(19) United States
(12) Patent Application Publication
(10) Pub. No.: US 2003/0112627 A1
(43) Pub. Date: Jun. 19, 2003

(54) Flexible sign illumination apparatus, system and method

(76) Inventor: Raymond E. Deese, Corona, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 09/969,119

(22) Filed: Sep. 27, 2001

Related U.S. Application Data
(60) Provisional application No. 60/236,211, filed on Sep. 28, 2000.

(51) Int. Cl. F21V 21/00; F21S 4/00

(52) U.S. Cl. 362/249; 362/800

(57) ABSTRACT

An energy efficient light strip illumination apparatus that can be easily installed with Velcro fasteners for both new installations and retrofitting incandescent and neon installations. One of the preferred embodiments is a flexible strip in which LED array's are imprinted in sections so that the strip can be cut to customize the size of the light strips to fit signs or other lighted features of any size or shape.

### PRIORITY CLAIM

This application claims the benefit of U.S. Provisional Application No. 60/236,211 filed Sep. 28, 2000 entitled “Flexible Sign Illumination Apparatus, System and Method.”

### FIELD OF THE INVENTION

This invention relates generally to illuminating light strips and, more particularly, to flexible LED light strips that are readily customized to fit signs and other lighted installations, and a system and a method for doing the same.

### BACKGROUND

Illuminated installations of various different shape, color and size are used to communicate with people. Their uses have an extremely wide range, from warning signs for motorists, to illuminated building facia, to a company's name on a skyscraper. The wide-spread use of these illuminations can be partially attributed to their visibility; in all weathers, day or night, illuminated signs, designs and indicia can be seen easily.

However, the advantages of illuminated signs and other installations come at a significant cost. To illuminate a sign from within, a transparent casing in the shape of the desired sign must be manufactured. Generally, incandescent or neon lights are permanently affixed inside the sign casing. In some cases, the light network must be customized to fit the unique dimensions of the sign. Therefore, installation of the lights into the signs can be time consuming and expensive.

Maintaining the signs is also costly. If one light burns out, an entire portion of the sign loses illumination. This is commonly seen when one or more letters of a sign are not visible at night due to a burnt out light. Furthermore, power consumption by incandescent and neon lighting is very high. This, in conjunction with the wide-spread use of these signs leads to mass consumption of electricity, placing a significant burden on the power plants and further polluting the environment. In sum, the installation of lights to fit the signs and maintenance of the sign are costly at many levels.

### SUMMARY OF THE INVENTION

The preferred embodiments of the present invention provide energy-efficient and reliable light strip illumination apparatus that can easily be customized and installed for both new installations and retrofitting incandescent and neon installations. One preferred embodiment includes a narrow strip flexible printed circuit board, energy efficient LED lights, a Velcro fastener, and power connectors. The LEDs are mounted onto one side of the circuit board and the fastener is attached to the opposite side of the circuit board. The power connectors couple multiple circuit boards to form a continuous network of lights.

The strip of flexible printed circuit board provides a platform for positioning the LEDs along the strip. The flexibility of the circuit board allows the light strip to be readily shaped to conform to the housing of the light fixture thereby enabling easy, inexpensive, and quick customization of lights to illuminate a sign or other installation.

In the preferred embodiments of the invention, the energy efficient LED lights are positioned in an array and the lights are electrically coupled in series within the array. A plurality of arrays are grouped to form a section and the arrays within the section are electrically coupled in parallel. Multiple sections are electrically coupled in parallel positioned along the circuit board. A feature of this construction is the partial burnout of an array of lights isolates light failure to that array only, which allows the rest of the lights to continue to provide illumination.

In one embodiment of the illumination system, multiple light strips are attached to a transparent sign casing where the receiving portions of Velcro fastener are attached to the designated areas. These strips are electrically coupled by power connectors. A “step down” transformer converts the line voltage from an electrical outlet into 24 volt AC current and supplies it to the LEDs through the power connector.

A feature of one of the preferred embodiments is that the printed circuits are laid out so that one or more sections of the flexible strip can be cut to customize the light strips to fit signs or other lighted features of any size or shape. Advantageously, marks are placed between the sections where the light strips can be cut.

In one preferred embodiment of a method of customizing and installing the light strips, the receiving portions of Velcro fastener are attached to the inside of the transparent sign casing. Equivalent lengths of the flexible light strip are bent to fit the shapes of the sign, measured, cut, and fastened onto the receiving portions of the Velcro fastener. The power connectors are used to electrically couple the strips and negotiate sharp angles for a better fit.

The use of Velcro fasteners attached to the strips allows easy attachment of the strips to the sign. The strips can be cut on-site to fit the dimensions of the sign. Using energy efficient lights such LEDs can reduce power consumption by six to ten times that of incandescent or gas tube lights in similar applications.

### BRIEF DESCRIPTION OF THE DRAWINGS

These and other features, aspects, and advantages of the present invention will become better understood with regard to the following description, appended claims, and accompanying drawings where:

FIG. 1 shows a plurality of light strips connected by a power connector and powered by a common household AC source using a step down transformer;

FIG. 2a shows sections of the light strip assembly powered by a battery;

FIG. 2b shows the bottom of the light strip, one showing the bare circuit board and the other showing the circuit board with Velcro fastener attached;

FIG. 3a shows a circuit diagram for one embodiment of the light strip powered by a battery;

FIG. 3b shows a circuit diagram for one embodiment of the light strip powered by AC input;

FIG. 4a shows coupling of multiple light strips by a power connector;

FIG. 4b shows the placement of power connectors on the light strip;

FIG. 5 shows one embodiment of the light strip using a Velcro fastener;

FIG. 6 shows flexibility of the sign illumination apparatus by bending to fit the inside of a letter “C”; and

FIG. 7 shows custom-fitting of the sign illumination apparatus in a letter “T,” where the power connectors are used to negotiate a sharp angle.

### DESCRIPTION

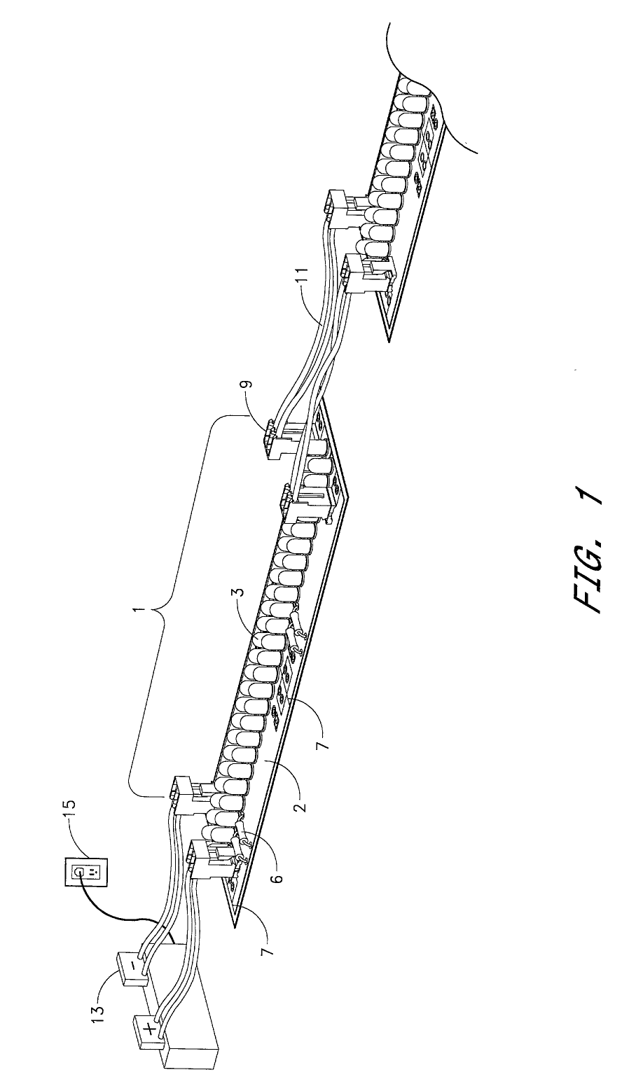

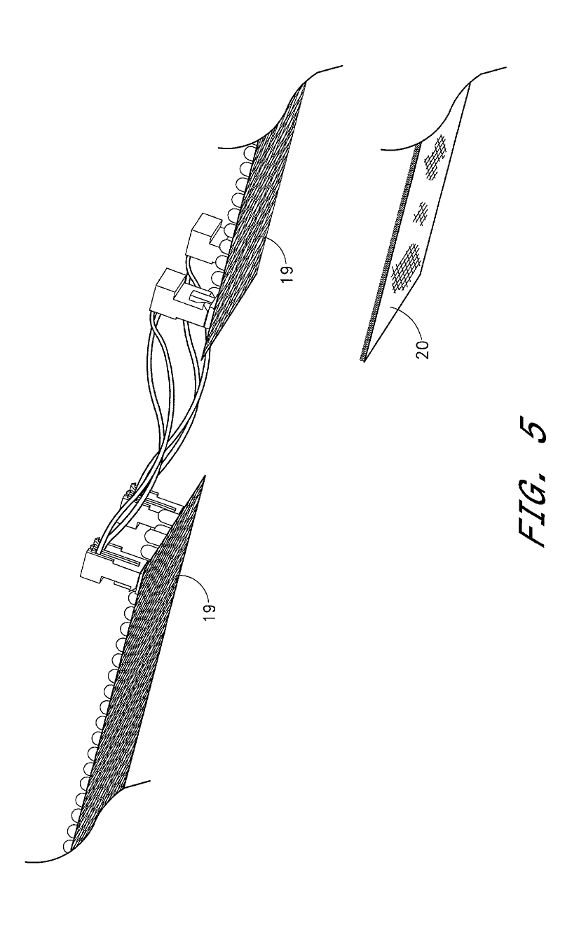

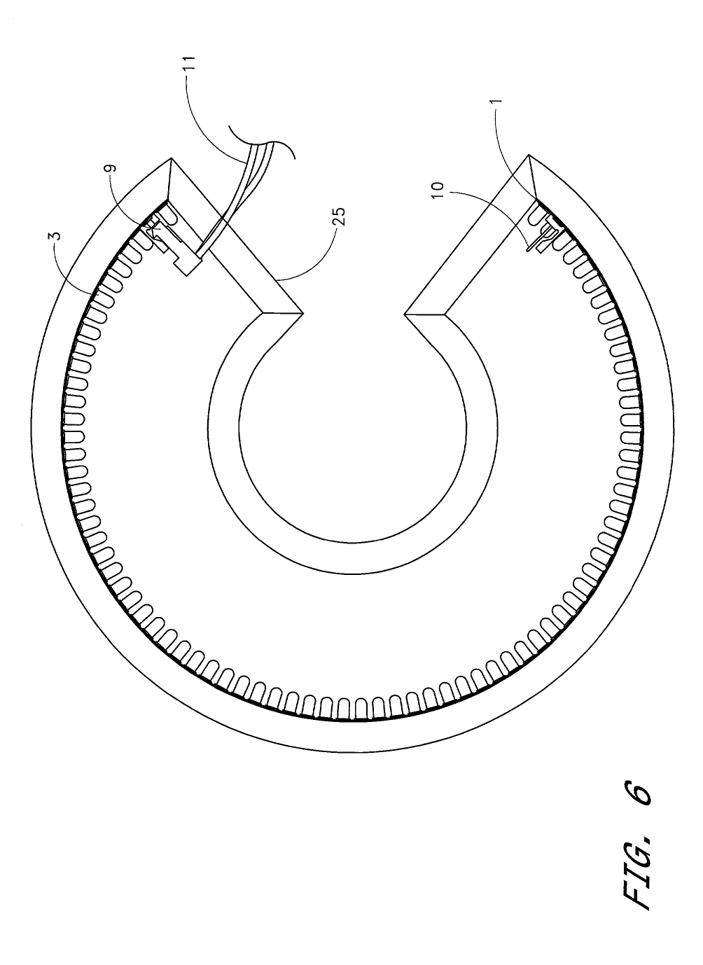

As shown in FIG. 1, an exemplary apparatus for sign illumination 1 comprises a flexible strip of printed circuit board 2, energy efficient lights 3, a fastener 19/20, (shown in detail in FIG. 5) and a power connector 11. The energy efficient LED lights 3 are mounted on the top of the circuit board strip 2 and the fastener 19 is attached to the bottom of the circuit board. The power connector 11 is coupled to the lights 3 as a conduit for electricity. In exemplary light strip systems, one or more of the strips 1 are electrically coupled end-to-end to each other by the power connectors 11.

Many types of flexible material may be used as a platform for the lights 3. A preferred choice is the Type FR4 inner core material that is approximately ten to twenty thousandth thickness. This type of material is readily available through vendors. In one embodiment, the circuit board 2 is in the shape of a strip that is flexible enough to bend to form a circle of approximately 2 inches in diameter. However, one skilled in the art will recognize that other suitable material with varying levels of flexibility can be cut in shapes other than a strip to provide a platform for the lights 3. For example, thinner sheets of laminated circuit boards may be used. The material does not have to be a circuit board material as long as it is flexible and allows electrical coupling of the lights 3.

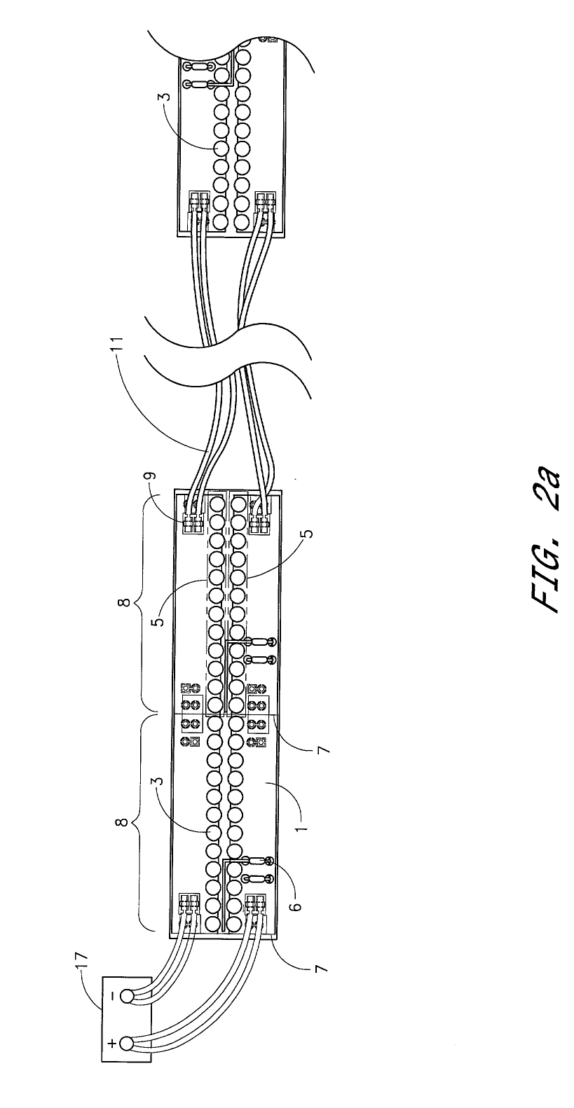

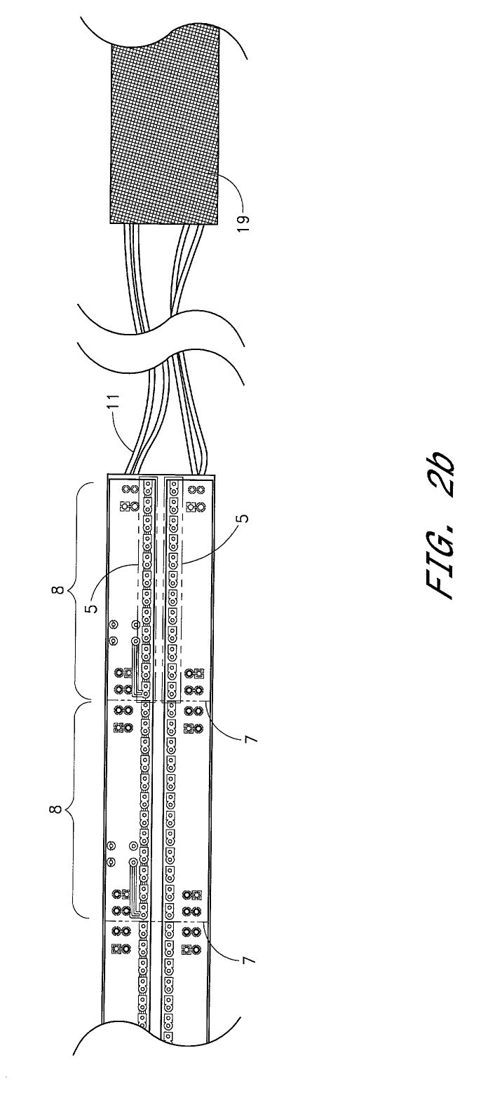

The energy efficient lights 3 are positioned in sections 8 of arrays 5. As shown in FIGS. 2a and 2b, twelve lights are grouped in arrays 5 and two arrays 5 are positioned next to each other to form a section 8. One or more sections 8 are placed along the circuit board 2, with severance areas 7 located between the sections 8. Resistors 6 are positioned out of the way of the lights 3. At least one set of terminals 4 are located on each section 8 for coupling with the power connector 11. One portion of a fastener 19 is attached to the bottom of the circuit board 2.

It will be obvious to one skilled in the art that the particular arrangement of the lights 3 and the location of the terminal 4 can be varied to suit the relevant application. For example, more than two arrays 5 can be positioned next to each other to form a wider section 8. The lights 3 can also be positioned in clusters with severance areas between the clusters and the terminals on the side of the strip rather than at the ends.

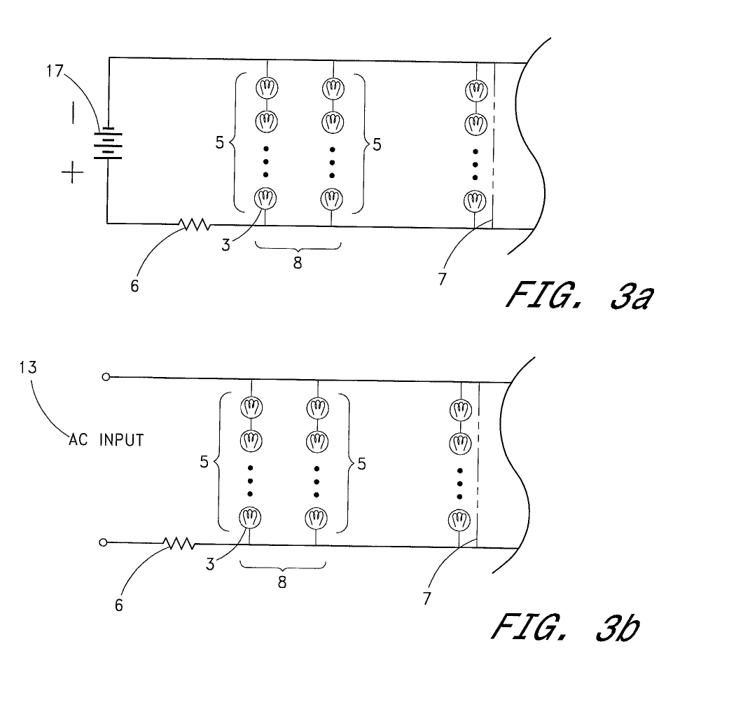

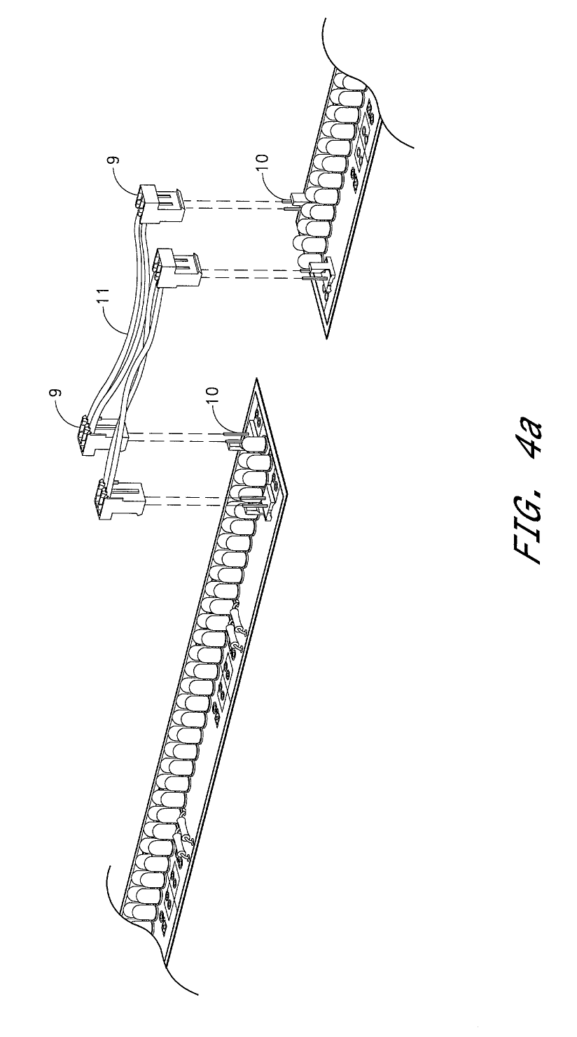

FIGS. 3a and 3b shows an exemplary circuit diagram of the light 3. The power source can be either DC current 17 or AC current 13. One or more resistors 6 can be used depending on the type of LED 3 used to moderate the electrical current and to protect against accidental electrical overload in cases where the rate of current is not constant. Resistors 6 may not be necessary if the rate of current is relatively constant. The lights 3 within the array 5 are connected in series. The arrays 5 are coupled to each other in parallel. The sections 8 are also connected in parallel. The severance area 7 can be any junction where a parallel connection is made. Other variations of circuit layouts that provide more or less flexibility in customization and limiting scope of light burn out may be used.

Many types of energy efficient illumination means are available in the market. In a preferred embodiment, light emitting diodes (LED) are used. The type of LED or equivalents thereof will depend on the required level of luminescence. LEDs consume approximately six to ten times less electricity. With the combination of serial and parallel electrical connections, a burnt out LED will cause light failure of one array only.

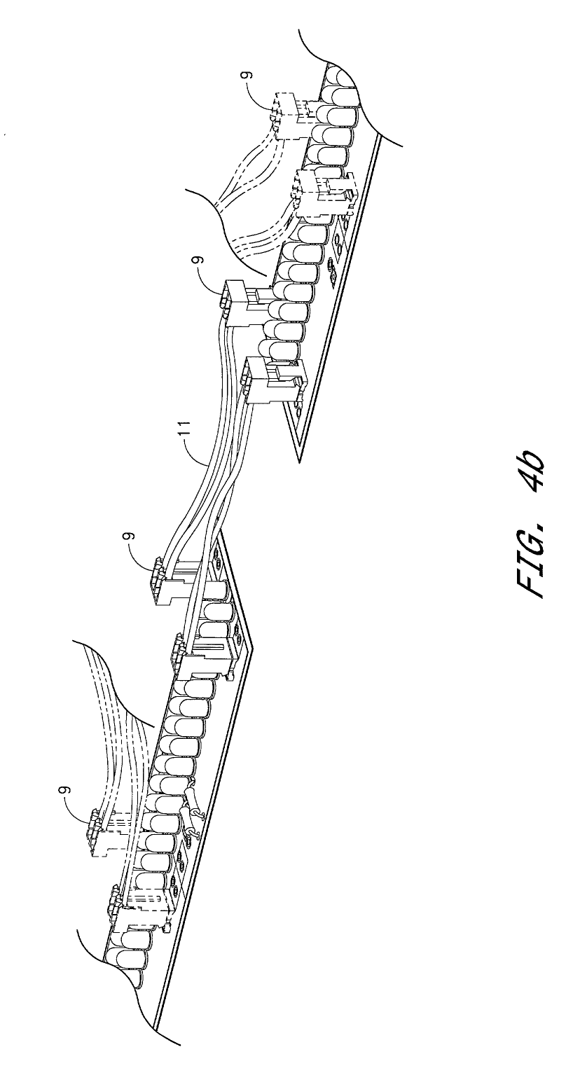

FIG. 4a shows the power connector 9 coupling multiple apparatus 1 and delivering electricity to the apparatus 1. A pin 10 is attached to a terminal 4. A power connector 11 having couplers 9 is coupled to the pins 10 to make an electrical connection. The same can be used for providing electricity to the apparatus 1. As shown in FIG. 4b, the power connectors 11 can be placed on any section 8 of the apparatus. It will be apparent to one skilled in the art that different electrical couplings can be used for coupling apparatus 1 to apparatus 1, and apparatus 1 to power source.

Many types of fastener can be used to position the light strip apparatus 1 in place. In one preferred embodiment of the invention as shown in FIG. 5, one part of a Velcro fastener 19 is attached to the bottom of the circuit board 2 in a way that will not cause a short circuit of the lights 3. The remaining part 20 of the Velcro is attached to any area where the light strips 1 may be placed. However, one skilled in the art will recognize that different types of fasteners—such as snaps, clips or suction cups—can be used.

As shown in the preferred embodiment of FIG. 6, the receiving portion of the Velcro fastener 20 is attached to the inner wall of the letter ‘C’ 25. Once the proper length is determined, the light strip 1 is severed to the proper length near the severance line 7 and fastened by the fastener 19 to the attached receiving portion 20 of the Velcro fastener. A power connector 11 is coupled to the power connector pin 10 through which power is supplied.

FIG. 6 illustrates the substantial advantage provided by the preferred embodiments of this invention for fitting virtually any sign or lighting fixture. As shown in the preferred embodiment of FIG. 6, the receiving portion of the Velcro fastener 20 is attached to the inner wall of the letter ‘C’ 25. Once the proper length is determined, the light strip 1 is severed to the proper length near the severance line 7 and fastened by the fastener 19 to the attached receiving portion 20 of the Velcro fastener. A power connector 11 is coupled to the power connector pin 10 through which power is supplied. The ability of the flexible circuit board to bend allows the light strip to precisely conform with the curve of the letter “C” sign. The ease by which the light strips of this invention can be shaped to fit virtually any sign configuration, building facia and the like enables the light strips of this invention to be used in both new signs and installations and for retrofitting to replace neon tubing and other high power usage lighting media. Thus, the preferred embodiments of the present invention have many advantages, including ease and speed of customization and installation.

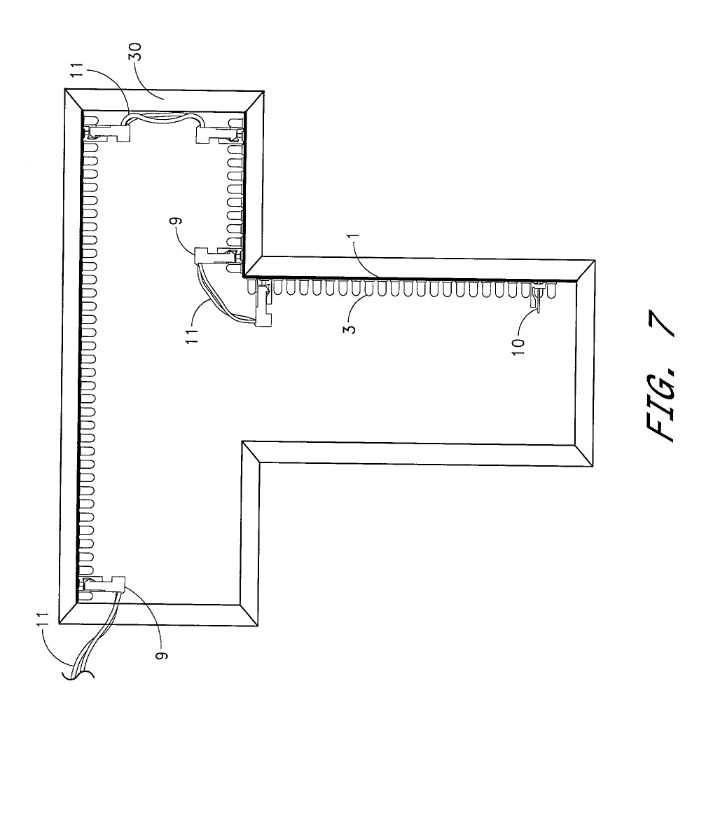

FIG. 7 shows an embodiment of a method of illuminating a sign using the light strip system. The receiving portion 20 of the Velcro fastener is attached to the inner wall of the letter ‘T’ 30. The light strip 1 is cut to three pieces to fit the sides of the letter ‘T’ 30 and attached to the receiving portion 20 of the Velcro fastener. Power connectors 11 are placed on the power connector pins 10 of each strip 1. The power connectors 11 between the strips 1 negotiates the sharp angles of the letter ‘T’ 30 to achieve an improved customization of the dimensions of the sign.

By way of specific example, the LED light strip 1 of FIG. 1 includes a strip 2 of Type FR4 inner core printed circuit board material of approximately ten to twenty thousandth thickness, two arrays 5 of twelve serially connected LEDs placed next to each other width-wise and connected in parallel forming a section 8. The sections are electrically connected in parallel along the strip 2, and severance spaces 7 are positioned between the sections 8. A first portion 19 of a Velcro fastener is cut to the shape of the strip 2 and attached to the bottom of the strip 2. AC input is drawn from an electrical outlet 15 to a step down transformer 13 to supply 24 volt electrical current to the LED strip 1. A set of resistors 6 are coupled between the transformer 13 and the LED strip 1 to prevent electrical overload. Electricity is delivered through a power connector 11 in cooperation with the coupler 9 and the pin 10.

Although the present invention has been described in considerable detail with reference to certain preferred versions thereof, other versions are possible. Therefore, the spirit and scope of the appended claims should not be limited to the description of the preferred versions.

What is claimed is:

1. An LED strip for lighting comprising:
a strip of flexible inner core circuit board material having a top and a bottom side, approximately one thousandth to two thousandth in thickness and sufficiently flexible to be bent into a circle of approximately 12 inches in diameter;
a plurality of LEDs mounted on the top side, electrically connected in series to form a linear array substantially shorter than the flexible circuit board;
one or more arrays electrically connected in parallel, the arrays positioned adjacent to each other to occupy the width of the strip to form a section;
one or more sections positioned along the strip, electrically connected in parallel;
one or more severance spaces positioned along the strip between the sections where the parallel connections are made; and
a fastener having a first and a second portion, wherein the first portion is attached to the bottom of the strip.

2. The LED strip of claim 1, further comprising a flexible electrical conduit connecting a plurality of strips.

3. The LED strip of claim 1 in which said linear array of LEDs are approximately 3 inches long.

4. An apparatus for lighting signs, building facia and the like comprising:
a flexible circuit board;
one or more LEDs coupled to one side of the circuit board; and
a Velcro fastener coupled to the other side of the circuit board.

5. The apparatus of claim 3, wherein the LED lights are electrically connected in series to form an array.

6. The apparatus of claim 4, further comprising a plurality of the arrays electrically connected in parallel to form a section.

7. The apparatus of claim 5, further comprising a plurality of severance spaces positioned between the sections.

8. The apparatus of claim 3, wherein the fastener is Velcro coupled to the bottom of the circuit board.

9. The apparatus of claim 3, further comprising a power source to the lights.

10. A light strip for lighting signs comprising:
a strip of bendable circuit board;
one or more lights coupled to the top of the circuit board, wherein a discrete array of lights are connected in series and one or more of the arrays are connected to each other in parallel;
one or more severance spaces between the arrays; and
a fastener attached to the bottom of the circuit board.

11. The light strip of claim 9, wherein the lights are LED.

12. The light strip of claim 9, wherein the fastener is Velcro.

13. The light strip of claim 9, further comprising a power source of approximately 24 volts coupled to the lights.

14. A system of illuminated sign comprising:
one or more light strips comprising;
a flexible circuit board,
one or more arrays of lights wherein the lights within the array are electrically connected in series and the arrays are electrically connected in parallel,
a fastener with a first and a second portion, wherein the first portion is coupled to the bottom of the circuit board;
one or more flexible power connectors coupling the light strips; and
a sign casing having at least one surface that is transparent, wherein the second portion of the fastener is attached to the areas of the casing where the light strip is to be positioned.

15. The system of claim 13, further comprising an approximately 110 volts or lower power source coupled to the light strip by the flexible power connectors.

16. The system of claim 13, wherein the lights are LED.

17. The system of claim 13, wherein the fastener is Velcro.

18. An apparatus for lighting signs comprising:
a plurality of illumination means;
one or more platforms for mounting the illumination means that allow serial and parallel electrical connections of the illumination means;
one or more means for electrical coupling coupled to the illumination means; and
a means for coupling the platform to a base attached to the platform.

19. The apparatus of claim 17, wherein the means for providing the platform is a printed circuit board.

20. The apparatus of claim 17, wherein the illumination means are LEDs.

21. The apparatus of claim 17, further comprising the illumination means electrically connected in series forming an array, the arrays electrically connected in parallel forming a section, the sections electrically connected in parallel along the platform.

22. The apparatus of claim 20, further comprising a severance area positioned between the sections positioned along the platform.

23. The apparatus of claim 21, further comprising a means for providing lower than 110 volts electricity to the illumination means.

24. The apparatus of claim 17, wherein the means for coupling is Velcro.

25. A method of providing lighting for signs, comprising:
bending a light strip having sets of serially connected lights connected in parallel, to approximately fit the sign;
cutting the light strip as needed to light the sign;
attaching one part of a fastener to the sign; and
fastening the light strip to the attached fastener.

26. The method of claim 24, further comprising providing lower than 110 volts electricity to the light strip.

27. The method of claim 24, wherein the strip is cut between two sections of lights where the parallel connection is made.

28. The method of claim 24, further comprising electrically coupling two or more light strips by a bendable power connector wherein sharp turns of the sign can be accommodated by the power connector.
